(19) United States
(12) Patent Application Publication
(10) Pub. No.: US 2004/0001419 A1
(43) Pub. Date: Jan. 1, 2004

(54) Compatible optical pickup using beams of different wavelength easy to assemble and adjust

(75) Inventors: Akira Ariyoshi, Nara-shi (JP); Hisayuki Shinohara, Kitakatsuragi-gun (JP); Katsushige Masui, Nara-shi (JP); Tetsuo Ueyama, Nara-shi (JP)

Correspondence Address: Barry E. Bretschneider, Morrison & Foerster LLP, Suite 300, 1650 Tysons Boulevard, McLean, VA, 22102, US

(73) Assignee: SHARP KABUSHIKI KAISHA, Osaka (JP)

(21) Appl. No.: 10/603,719

(22) Filed: Jun. 26, 2003

(30) Foreign Application Priority Data
Jun. 27, 2002 (JP) 2002-187799
May 20, 2003 (JP) 2003-142091

(51) Int. Cl. G11B 7/135

(52) U.S. Cl. 369/112.04; 369/112.15; 369/112.19

(57) ABSTRACT

First, second semiconductor lasers and a photodetector are integrated in a laser package of an integrated laser unit. A composite PBS is so structured that generally 100% of s-polarized light derived from the first semiconductor laser is reflected while generally 100% of s-polarized light derived from the second semiconductor laser is transmitted. Then, return beams of s-polarized light of the first, second semiconductor lasers separated by the composite PBS 18 are converged on the same photodetector by the first, second polarization hologram devices. By doing so, the first, second polarization hologram devices are adjusted independently of each other, so that the offset adjustment of servo error signals for the first, second semiconductor lasers can be easily achieved in assembly process. Thus, the optical pickup becomes easy to assemble and adjust.

### BACKGROUND OF THE INVENTION

The present invention relates to optical pickups for optically recording and reproducing information to and from information recording mediums such as optical disks and optical cards. In particular, the invention relates to a compatible optical pickup ready for optical disks of plural different specifications on which recording and reproduction are performed by using optical beams of different wavelengths.

In recent years, optical disks have been being increasingly widely used in various fields such as audio, video and computers by virtue of their capability of recording larger amount of information signals with high density.

Together with this trend, in those optical disk fields, there have been commercialized discs such as CD (Compact Disc), CD-R (Compact Discs Recordable) and DVD (Digital Versatile Disc) in various different specifications. Therefore, it is required for such discs of different specifications to have a compatibility that allows those discs to be recorded or reproducted with a single optical pickup. CDs or CD-Rs have disc-substrate or recording-medium characteristics optimized to an infrared beam of a wavelength of 780 nm, while DVDs have disc-substrate or recording-medium characteristics optimized to red light beams of wavelengths around 650 nm. Further, for future use, there have been being developed discs on which recording and reproduction are performed by using blue light beams of wavelengths around 400 nm.

As an optical pickup having a compatibility with discs on which recording or reproduction is performed with different wavelengths as shown above, there has been proposed an optical pickup having such a constitution as shown in FIG. 14 as an example (Japanese Patent Laid-Open Publication HEI 9-128794).

This optical pickup has a first semiconductor laser 1 which oscillates on a 635 nm band, a second semiconductor laser 2 which oscillates on a 780 nm band, a three-beam diffraction grating 3 for generating three beams for use of tracking control from optical beams of the two semiconductor lasers 1, 2, a grating lens 4 which fulfills a concave lens action depending on the direction of polarization of an optical beam, an objective lens 5, and a hologram device 7 for diffracting light reflected from an optical disk 6 and leading it to a photodetection device 8. In this case, the first semiconductor laser 1 and the second semiconductor laser 2 are so positioned that their directions of polarization are perpendicular to each other.

The optical pickup of this constitution operates as follows. First explained is an optical system for reproducing an optical disk 6 having a substrate thickness of 0.6 mm by the first semiconductor laser 1 of the 635 nm band.

Light emitted from the first semiconductor laser 1 is split into three beams by the three-beam diffraction grating 3. Then, after transmitted by the hologram device 7, the beams are subjected to no action by the grating lens 4, coming incident on the objective lens 5 and being focused on the optical disk 6 by the objective lens 5. Then, the light reflected by the optical disk 6 and thus returned is diffracted by the hologram device 7 and thus led to the photodetector device 8. That is, the grating pattern is so formed that the direction of polarization of an optical beam derived from the first semiconductor laser 1 is not subject to any action by the grating lens 4.

Next explained is an optical system for reproducing an optical disk 6 having a substrate thickness of 1.2 mm by the second semiconductor laser 2 of the 780 nm band.

Light emitted from the second semiconductor laser 2 is split into three beams by the three-beam diffraction grating 3 as in the foregoing case. Then, after transmitted by the hologram device 7, the beams are subjected to a concave lens action by the grating lens 4, coming incident on the objective lens 5 and being focused on the optical disk 6 by the objective lens 5. Then, the light reflected by the optical disk 6 and thus returned is diffracted by the hologram device 7 and thus led to the photodetector device 8 as in the foregoing case. That is, the grating pattern is so formed that the direction of polarization of an optical beam derived from the second semiconductor laser 2 is subject to an action by the grating lens 4.

It is noted that the concave lens action by the grating lens 4 is so designed that a spherical aberration occurring when the optical disk 6 is increased in thickness from 0.6 mm to 1.2 mm is corrected.

With this constitution, for example for the first semiconductor laser 1, the hologram device 7 is so designed that the diffracted light of reflected light derived from the optical disk 6 is led to the photodetector device 8. Accordingly, out of the reflected light from the optical disk 6, with respect to the reflected light of the second semiconductor laser 2 having a different wavelength, light diffracted by the hologram device 7 is led to a position on the photodetector device 8 different from that of reflected light of the first semiconductor laser 1, depending on a difference of diffraction angle due to a difference of wavelength from reflected light of the first semiconductor laser 1. Therefore, the placement relationship of the second semiconductor laser 2 is so set that the difference of incidence position on the photodetector device 8 is canceled with respect to the second semiconductor laser 2 of the different wavelength.

Also, the emission light from the first semiconductor laser 1 and the emission light from the second semiconductor laser 2 are, in either case, split into three beams as well by the three-beam diffraction grating 3, and then any tracking error signal for use of the three-beam technique is detected by the one photodetector device 8.

With such a constitution adopted, whereas it would basically be necessary to provide two photodetectors for the first semiconductor laser 1 and the second semiconductor laser 2, using one photodetector device 8 in common has made it implementable to reduce the number of component parts or the number of assembly man-hours.

However, the above conventional optical pickup having a compatibility as disclosed in Japanese Patent Laid-Open Publication HEI 9-128794 has the following problems.

That is, as described above, in the optical pickup, the positional relationship of the semiconductor lasers 1, 2 of a plurality of wavelengths is set to a certain value, so that beams of reflected light are led to the common photodetector device 8 by one hologram device 7. However, normally, in the case where the semiconductor lasers and the photodetector are integrated in one package, those semiconductor lasers and photodetector are positioned on and fixed to the stem within the package, in which case it would often be impossible to perform positional alignment or rotational adjustment on the photodetector side in the process of adjusting the hologram device.

Then, in the conventional optical pickup, in the case where the offset adjustment of servo error signals (e.g., focusing error signal and tracking error signal) occurring due to mounting errors of the two semiconductor lasers 1, 2 and the photodetector device 8 or to the form tolerance of the mounting surface of the hologram device 7 is performed only by the adjustment of the hologram device 7, it becomes more likely that adjusting the hologram device 7 for matching with one semiconductor-laser light source would cause the state of the hologram device 7 to be shifted from an optimum state with respect to the other semiconductor-laser light source.

That is, there is a problem that an optimum adjustment of servo error signals could not be attained only by adjusting the position of the hologram device 7 in assembly process. Otherwise, there is a need that mounting tolerances of the semiconductor lasers 1, 2 and the photodetector device 8 or machining tolerance of the package or other tolerance be set much stricter, which would cause a problem of increased cost. Further, generally, the hologram device 7 in many cases includes an aberration correcting function to obtain a desired focusing property on the photodetector device 8. However, it is very difficult to design a hologram pattern that allows an optimum aberration correction to be achieved against plural different wavelengths.

Also, the above conventional optical pickup having a compatibility could detect only tracking error signals for use with the three-beam technique, in either case, with respect to the light beams of the semiconductor lasers 1, 2 of a plurality of wavelengths. As a result, there is another problem that the optical pickup cannot be applied to optical disks of plural different specifications including optical disks of a specification involving the use of different tracking error signals. Further, return light from the optical disk 6 is diffracted by the hologram device 7 so as to be led to the photodetector device 8. As a result, the 0th-order light is not led to the photodetector device 8, posing a further problem of decreased use efficiency of light.

### SUMMARY OF THE INVENTION

It is therefore an object of the present invention to provide an optical pickup which is capable of performing recording and reproduction with optical beams of different wavelengths, easy to assemble and adjust and suitable for downsizing and integration, and compatible with optical disks of plural different specifications. It is a further object of the present invention to provide an optical pickup which is capable of leading all the beams of return light from the optical disks to the photodetector, allowing high use efficiency of light to be obtained, and which is capable of detecting different tracking error signals by a photodetector of the absolutely same constitution.

In order to achieve the above objects, according to the optical pickup of the present invention, light of a first wavelength derived from a first light source and light of a second wavelength derived from a second light source, after reflected by an optical disk, are separated from each other by an optical device. Then, the separated beam of the first wavelength is diffracted by a first hologram device so as to be incident on the photodetector, while the separated beam of the second wavelength is diffracted by the second hologram device so as to be incident on the photodetector. Thus, by providing the first hologram device for light of the first wavelength and the second hologram device for light of the second wavelength independently of each other, it becomes possible to adjust the first, second hologram devices independently of each other.

Accordingly, even when the first, second light sources and the photodetector are integrated in one package, the offset adjustment of a servo error signal for both light sources can be easily achieved in assembly process. Thus, there is provided an optical pickup which is easy to assemble and adjust and which is suitable for downsizing and integration.

Also, since the first, second hologram devices are provided independently of each other, the optical pickup can be given an aberration correcting function for oscillation wavelengths corresponding to the hologram devices, respectively, thus making it possible to perform an optimum aberration correction for a plurality of different wavelengths. Thus, desired focusing property on the photodetector becomes obtainable on the photodetector.

Further, at least one of the two hologram devices is a polarization hologram device. Therefore, when the polarization direction of a beam emitted from a light source on the side on which the beam is diffracted by the polarization hologram device is set so that the 0th-order diffraction efficiency of the reflected light by the optical disk is minimized, all the return light from the optical disk is led to the photodetector, thus allowing the use efficiency of light to be largely improved.

In one embodiment of the present invention, the first light source, the second light source, the photodetector, the optical device, the first hologram device and the second hologram device are integrated into one unit. Thus, by the integration of the first, second light sources, the photodetector, the optical device and the first, second hologram devices in one package, there is provided an optical pickup which is easy to assemble and adjust and which is suitable for downsizing and integration.

Also, in an optical pickup of one embodiment, the optical device is a wavelength-splitting prism which differs in reflectivity depending on wavelength. Then, light reflected by the wavelength-splitting prism is diffracted by the first hologram device so as to be incident on the photodetector, while light transmitted by the wavelength-splitting prism is diffracted by the second hologram device so as to be incident on the photodetector. Thus, a beam of the first wavelength and a beam of the second wavelength are easily separated from each other so as to be incident on the same photodetector through different paths.

Also, in an optical pickup of one embodiment, the optical device is a composite polarization beam splitter which transmits generally all of p-polarized light and reflects generally all of s-polarized light out of the optical beam of the first wavelength and which transmits generally all of both p-polarized light and s-polarized light out of the optical beam of the second wavelength, while a ¼ wave plate which rotates a polarization direction of the light of the first wavelength by 90 degrees is disposed between the composite polarization beam splitter and the optical system. Therefore, when p-polarized light of the first wavelength is emitted from the first light source, this p-polarized light is transmitted, as it is, by the composite polarization beam splitter, and transformed into circularly polarized light by the ¼ wave plate, thus being incident on the optical disk. Then, the reflected light from the optical disk is formed into s-polarized light by the ¼ wave plate, and reflected by the composite polarization beam splitter. Thus, the beam is completely separated from the beam of the second wavelength derived from the second light source that is not affected by the composite polarization beam splitter or the ¼ wave plate.

In one embodiment of the present invention, the ¼ wavelength plate rotates a polarization direction of light of the second wavelength as well by 90 degrees. Therefore, when p-polarized light of the second wavelength is emitted from the second light source, this p-polarized light is transmitted, as it is, by the composite polarization beam splitter, and transformed into circularly polarized light by the ¼ wave plate, thus being incident on the optical disk. Then, the reflected light from the optical disk is formed into s-polarized light by the ¼ wave plate, and transmitted as it is by the composite polarization beam splitter. Thus, the beam is completely separated from the beam of the first wavelength reflected by the composite polarization beam splitter.

In one embodiment of the present invention, the ¼ wavelength plate is adhesively fixed to a surface of the composite polarization beam splitter confronting the optical system. Therefore, the optical device for separating the reflected light of the first wavelength and the reflected light of the second wavelength derived from the optical disk from each other is made compact, so that downsizing and integration of the optical pickup becomes implementable.

In one embodiment of the present invention, the first hologram device and the second hologram device are polarization hologram devices which are so set that ±1st-order diffraction efficiency of the s-polarized light and 0th-order diffraction efficiency of the p-polarized light are maximized while 0th-order diffraction efficiency of the s-polarized light and ±1st-order diffraction efficiency of the p-polarized light are minimized. Therefore, emitted light beams of the first, second wavelengths, which are p-polarized light, are transmitted as they are by the second hologram device. Meanwhile, reflected light beams of the first, second wavelengths, which are s-polarized light, are diffracted by the first, second hologram devices so as to be led generally in all to the same photodetector. Thus, the use efficiency of light is largely improved.

In one embodiment of the present invention, the photodetector includes a divisional photodetection device which is two-divided so as to have two photodetection regions by a parting line extending along a direction corresponding to a radial direction of the optical disk,

meanwhile, the first hologram device and the second hologram device each include one diffraction region resulting from the two-division by the parting line extending along the direction corresponding to the radial direction of the optical disk, and wherein

upon focusing, light diffracted at the one diffraction region out of the optical beam of the first wavelength and the optical beam of the second wavelength forms a light spot on the parting line of the divisional photodetection device. Therefore, it becomes possible to detect a focusing error signal of the single knife edge method based on outputs corresponding to light amounts received by the two photodetection regions of the divisional photodetection device.

In one embodiment of the present invention, a three-beam diffraction grating is provided between the first, second light sources and the second hologram device. In one embodiment of the present invention, the three-beam diffraction grating is a wavelength-selective diffraction grating which transmits generally all of the optical beam of the first wavelength and splits the optical beam of the second wavelength into three beams of 0th-order light and ±1st-order light. Therefore, it becomes possible to detect, by means of the photodetector, a tracking error signal of the three-beam method for light of the second wavelength and a tracking error signal of any method other than the foregoing three-beam method for light of the first wavelength.

In one embodiment of the present invention, the photodetector is made up of a plurality of photodetection devices which are arrayed in such a manner that a tracking error signal of a differential phase method or a push-pull method can be detected based on light diffracted by the first hologram device and that a tracking error signal of a three-beam method or a differential push-pull method can be detected based on light diffracted by the second hologram device. Therefore, it becomes possible to detect, by means of the photodetector, tracking error signals of different methods including the three-beam method, the differential phase method, the push-pull method and the differential push-pull method.

In one embodiment of the present invention, the photodetector is made up of a plurality of photodetection devices which are arrayed in such a manner that diffracted light of the optical beam of the second wavelength by the first hologram device is not made incident on the photodetector. Therefore, when detecting outputs of the photodetection devices by the beam of the second wavelength derived from second hologram device, the incidence of any stray light derived from the first hologram device is prevented, so that adverse effects such as noise or offset due to the stray light are eliminated.

In one embodiment of the present invention, the photodetector is made up of a plurality of photodetection devices which are arrayed in such a manner that diffracted light of the optical beam of the first wavelength by the second hologram device is not made incident on the photodetector. Therefore, when detecting outputs of the photodetection devices by the beam of the first wavelength derived from first hologram device, the incidence of any stray light derived from the second hologram device is prevented, so that adverse effects such as noise or offset due to the stray light are eliminated.

In one embodiment of the present invention, the photodetector comprises a first photodetector on which diffracted light from the first hologram device comes incident, and a second photodetector on which diffracted light from the second hologram device comes incident. Therefore, it becomes possible to adopt mutually different detection methods suitable for information signals which are recorded on an optical disk that allows information to be read by an optical beam of the first wavelength and an optical disk that allows information to be read by an optical beam of the second wavelength, respectively.

In one embodiment of the present invention, the first light source is a first semiconductor laser which oscillates on a 650 nm band, and

the second light source is a second semiconductor laser which oscillates on a 780 nm band. Therefore, it becomes possible to perform recording and reproduction on optical disks of DVDs and CDs of different specifications.

In one embodiment of the present invention, at least one of the first semiconductor laser and the second semiconductor laser is a high-power laser, and

recording and reproduction onto the optical disk with the high-power laser is enabled. Therefore, it becomes possible to perform recording and reproduction on CD-R and CD-RW by means of a high output laser.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a view showing the constitution of an optical pickup according to the present invention;

FIG. 2 is an enlarged detailed view of an integrated laser unit of FIG. 1;

FIG. 3 is a view showing the diffraction region configuration of a first polarization hologram device as well as the photodetector device configuration shown in FIG. 2;

FIG. 4 is a view showing a relationship between the diffraction region configuration of a second polarization hologram device and each photodetection device shown in FIG. 2;

FIG. 5 is an explanatory view of stray light from the second polarization hologram device side;

FIG. 6 is an explanatory view of stray light from the first polarization hologram device side;

FIG. 7 is a view showing a relationship between the photodetection device configuration and the diffraction region configuration of the first polarization hologram device, other than that of FIG. 3;

FIG. 8 is a view showing a relationship between the photodetection device configuration shown in FIG. 7 and the diffraction region configuration of the second polarization hologram device;

FIG. 9 is a view showing a relationship between the photodetection device configuration and the diffraction region configuration of the first polarization hologram device, other than those of FIG. 3 and FIG. 7;

FIG. 10 is a view showing the photodetection device configuration shown in FIG. 9 and the diffraction region configuration of the second polarization hologram device;

FIG. 11 is a view showing a state during DVD reproduction with a constitution of an optical pickup different from that of FIG. 1;

FIG. 12 is a view showing a state during recording and reproduction on a CD-R or a CD-RW with the optical pickup shown in FIG. 11;

FIG. 13 is a view showing a constitution of an optical pickup different from those of FIG. 1 and FIG. 11; and

FIG. 14 is a view showing a constitution of an optical pickup according to a prior art.

### DETAILED DESCRIPTION OF THE PREFERRED EMBODIMENTS

Hereinbelow, the present invention is described in detail by way of embodiments thereof illustrated in the accompanying drawings.

First Embodiment:

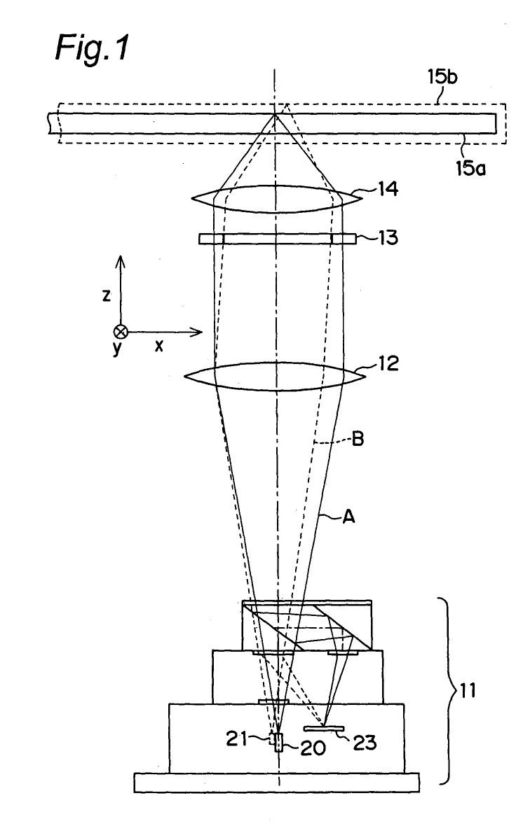

FIG. 1 is a view showing the constitution of an optical pickup in this embodiment. In FIG. 1, an integrated laser unit 11 is a characteristic part of this invention, and its constitution will be described in detail later. Light emitted from the integrated laser unit 11 is collimated by a collimator lens 12, transmitted through a wavelength-selector aperture 13, and then focused on an optical disk 15 by an objective lens 14. Then, reflected light from the optical disk 15, retracing the same optical system as that in the forward direction, is focused on the photodetector of the integrated laser unit 11.

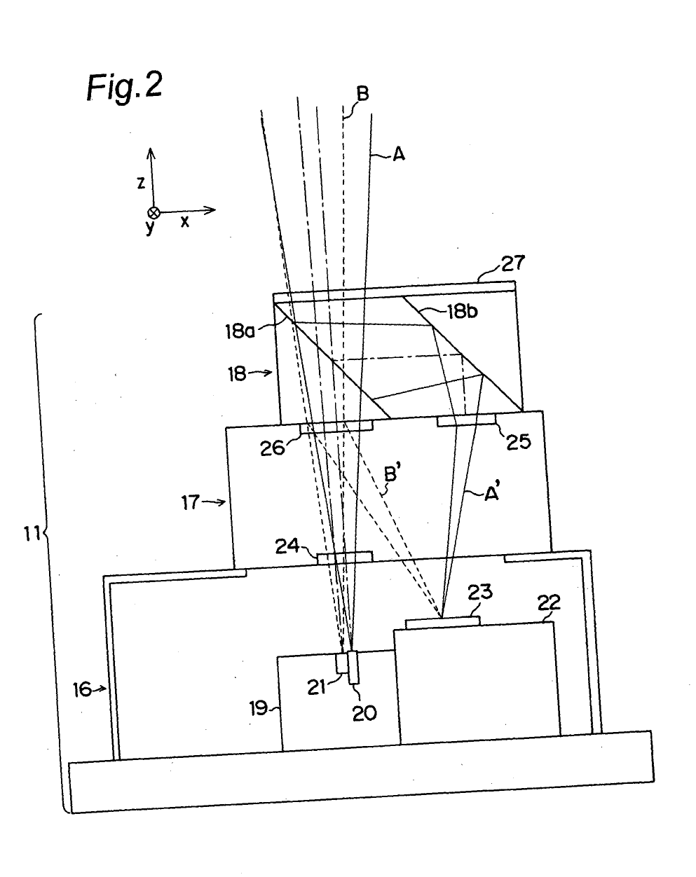

FIG. 2 is an enlarged detailed view of the integrated laser unit 11 of FIG. 1. Hereinbelow, the integrated laser unit 11 is explained in detail according to FIG. 2. The integrated laser unit 11 is made up of a laser package 16, a transparent substrate 17, and a composite polarized beam splitter (composite PBS) 18, all of which are stacked on the substrate in this order.

The laser package 16 contains therein a laser stand 19 on which a first semiconductor laser 20 that oscillates on a 650 nm band and a second semiconductor laser 21 that oscillates on a 780 nm band are disposed in proximity to each other and thus mounted, and a detector stand 22 on which a photodetector 23 is mounted.

Also, on one surface of the transparent substrate 17 in close contact with the laser package 16, a three-beam diffraction grating 24 for generating three beams for use of tracking control is formed at a position opposite the first, second semiconductor lasers 20, 21. Further, on the surface of the transparent substrate 17 in close contact with the composite PBS 18 are formed a first polarization hologram device 25 which diffracts an optical beam of the first semiconductor laser 20 coming from the composite PBS 18 to lead the beam to the photodetector 23, and a second polarization hologram device 26 which diffracts an optical beam of the second semiconductor laser 21 coming from the composite PBS 18 to lead the beam to the photodetector 23.

The composite PBS 18 has a polarization beam splitter surface 18a and a reflection surface 18b. Then, a wave plate 27 is stacked on one surface of the composite PBS 18 which is not in close contact with the transparent substrate 17.

In addition, the laser package 16, the transparent substrate 17, the composite PBS 18 and the wave plate 27 are integrally bonded and fixed together.

Now a method for reproducing different optical disks by the optical pickup having the above constitution is described in detail below.

First, for reproduction of the above-mentioned DVD, an optical beam A emitted from the first semiconductor laser 20 of the 650 nm band, as shown by solid line, is transmitted by the three-beam diffraction grating 24, the second polarization hologram device 26, the polarization beam splitter surface 18a of the composite PBS 18 and the wavelength plate 27, and thus led to the collimator lens 12. Then, after collimated by the collimator lens 12, the beam A is transmitted through the wavelength-selector aperture 13 and focused on an optical disk 15a by the objective lens 14. Then, return light A′ reflected by the optical disk 15a is transmitted by the objective lens 14, the wavelength-selector aperture 13 and the collimator lens 12, and thus led to the integrated laser unit 11. Then, after reflected by the polarization beam splitter surface 18a and reflection surface 18b of the composite PBS 18, the beam is diffracted by the first polarization hologram device 25 and focused on a photodetection device (not shown) of the photodetector 23.

On the other hand, for reproduction of the above-mentioned CD, an optical beam B emitted from the second semiconductor laser 21 of the 780 nm band, as shown by broken line, is split into three beams by the three-beam diffraction grating 24, and thereafter is transmitted by the three-beam diffraction grating 24, the second polarization hologram device 26, the polarization beam splitter surface 18a of the composite PBS 18 and the wavelength plate 27, and thus led to the collimator lens 12. Then, after collimated by the collimator lens 12, the beams are subjected to aperture restriction at the wavelength-selector aperture 13 and focused on an optical disk 15b by the objective lens 14. Then, return light B′ is transmitted by the objective lens 14, the wavelength-selector aperture 13 and the collimator lens 12, and thus led to the integrated laser unit 11. Then, the beams are transmitted by the polarization beam splitter surface 18a of the composite PBS 18, diffracted by the second polarization hologram device 26 and focused on a photodetection device of the photodetector 23.

In this operation, the wavelength-selector aperture 13 acts by its wavelength selector film so that, for example, light of 650 nm is transmitted therethrough while light of 780 nm is subjected to an aperture restriction with an NA (Numerical Aperture) of 0.45 of the objective lens 14. Also, the objective lens 14 is basically formed into such an aspherical shape that a sufficiently small aberration is obtained with a substrate thickness of 0.6 mm for a beam of light with a wavelength of 650 nm and an NA of 0.6, and moreover the objective lens 14 has been corrected in partial shape so that out of the beam of light with the wavelength of 780 nm, only its part in a region around the NA of 0.45, where the aberration is large, is focused on the optical disk having a substrate thickness of 1.2 mm. Accordingly, a sufficiently small aberration can be obtained with respect to light beams emitted from the two different first, second semiconductor lasers 20, 21.

Next, the relationship between the polarization direction of a laser beam and the composite PBS 18 as well as the first, second polarization hologram devices 25, 26 is explained. The polarization beam splitter surface 18a of the composite PBS 18 has polarization characteristics that it transmits generally 100% of p-polarized light and reflects generally 100% of s-polarized light with respect to the wavelength derived from the first semiconductor laser 20 of the 650 nm band, while the polarization beam splitter surface 18a of the composite PBS 18 transmits generally 100% of both p-polarized light and s-polarized light with respect to the wavelength from the second semiconductor laser 21 of the 780 nm band.

Also, the first polarization hologram device 25 and the second polarization hologram device 26 are devices which are formed by cutting a diffraction grating on a special substrate, and which make the ratio of 0th-order light to 1st-order light largely varied according to the directions of polarization (p polarization and s polarization) of a transmitted laser beam. That is, when the transmitted laser optical beam is p polarized light, generally all of the light becomes 0th-order light, and almost no ±1st-order light is generated. On the other hand, when the transmitted optical beam is s polarized light, generally all of the light becomes ±1st-order light, and almost no 0th-order light is generated.

Also, the wavelength plate 27 is set to such a thickness that a phase difference corresponding to a ¼ wavelength plate is generated for the wavelength from the first semiconductor laser 20 of the 650 nm band while a phase difference corresponding to a ¼ wavelength plate is generated also for the wavelength from the second semiconductor laser 21 of the 780 nm band.

The three-beam diffraction grating 24 is a wavelength-selective diffraction grating which transmits generally all of the optical beam from the first semiconductor laser 20 of the 650 nm band, and which splits the optical beam from the second semiconductor laser 21 of the 780 nm band into three beams of 0th-order light and 1st-order light. It is noted that this wavelength-selective diffraction grating can be implemented by a polarization hologram or a hologram adjusted in the depth of its grooves.

With the composite PBS 18, the first, second polarization hologram devices 25, 26, and the wavelength plate 27 having the above-described constitutions, for reproduction of a DVD as an example, p-polarized light (linearly polarized light in the x direction in FIGS. 1 and 2) A emitted from the first semiconductor laser 20 is transmitted by the polarization beam splitter surface 18a, and formed into circularly polarized light by the wave plate (¼ wavelength plate) 27, thus being incident on the optical disk 15a. Then, return light A′ reflected by the optical disk 15a is allowed to be incident again on the wavelength plate (¼ wavelength plate) 27, thus being formed into s-polarized light (linearly polarized light in the y direction). Therefore, the return light A′ is reflected by the polarization beam splitter surface 18a and the reflection surface 18b so as to be incident on the first polarization hologram device 25. Then, generally all of the return light A′ is formed into ±1st-order light and focused on the photodetector 23 by the first polarization hologram device 25.

Thus, in reproduction of the DVD, generally all of the return light A′ from the optical disk 15a can be led to the photodetector 23 side, thus making it achievable to largely improve the use efficiency of light.

Further, for reproduction of the CD, p-polarized light B emitted from the second semiconductor laser 21 is transmitted by the polarization beam splitter surface 18a, and formed into circularly polarized light by the wavelength plate 27, thus being incident on the optical disk 15b. Then, return light B′ reflected by the optical disk 15b is allowed to be incident again on the wavelength plate 27, thus being formed into s-polarized light. Since the polarization beam splitter surface 18a transmits light of all the wavelengths emitted from the second semiconductor laser 21, all of the return light B′ is allowed to be incident on the second polarization hologram device 26. Then, most part of the return light B′, which is s-polarized light, is diffracted by the second polarization hologram device 26 so as to be formed into ±1st-order light and focused on the photodetector 23.

Thus, also in reproduction of the CD, all of the return light B′ from the optical disk 15b can be led to the photodetector 23 side, thus making it achievable to largely improve the use efficiency of light.

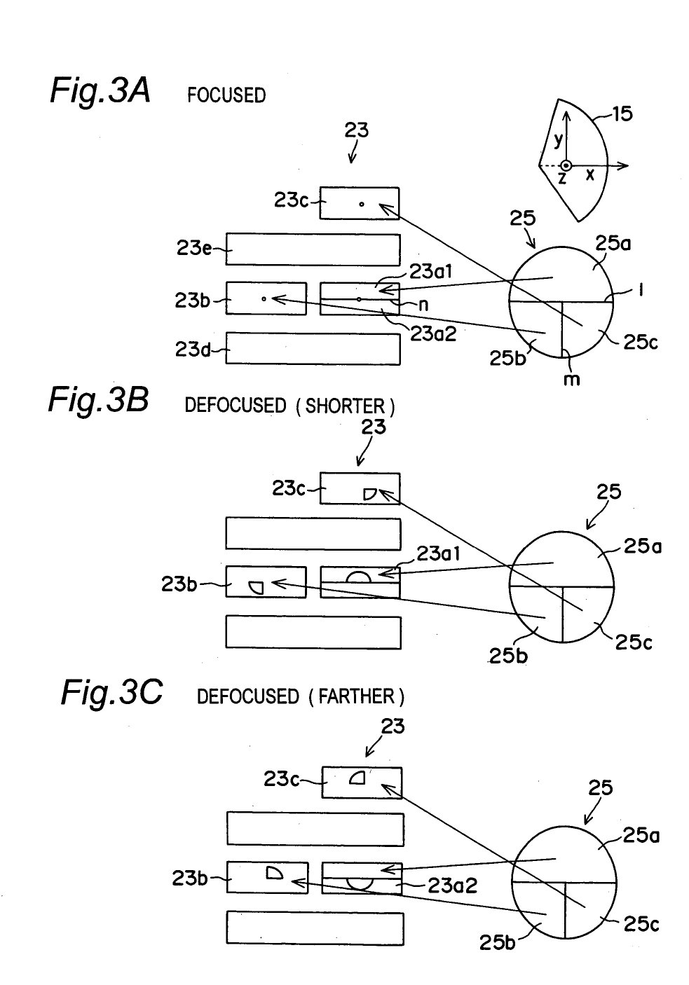

Next, structures of the first polarization hologram device 25, the second polarization hologram device 26 and the photodetector 23 as well as the servo signal detection method are explained. FIG. 3 shows the diffraction region configuration of the first polarization hologram device 25 as well as the photodetector device configuration of the photodetector 23.

As shown in FIG. 3, the first polarization hologram device 25 is divided into three regions 25a, 25b, 25c by a parting line l in the x direction, which corresponds to the radial direction of the optical disk 15, and a parting line m in the y direction, which corresponds to the track direction. Also, the photodetector 23 is made up of a two-divisional photodetection device 23a, which is divided by an x-direction parting line n into two photodetection regions 23a1, 23a2, and four photodetection devices 23b-23e. In addition, outputs from the individual photodetection regions 23a1, 23a2 and the individual photodetection devices 23b-23e are designated by Sa1, Sa2 and Sb-Se, respectively.

For instance, servo signal detection in reproduction of the DVD is carried out as follows. That is, as described above, the return light A′ from the optical disk 15a, originating from the light emitted from the first semiconductor laser 20, is allowed to be incident on the first polarization hologram device 25 in the manner as described above.

Then, in the case where the optical beam A converged by the objective lens 14 is focused on the information recording surface of the optical disk 15a, as shown in FIG. 3A, out of the incident optical beam A′, light diffracted by the region 25a of the first polarization hologram device 25 is converged on the parting line n of the photodetection regions 23a1, 23a2 in the two-divisional photodetection device 23a, light diffracted by the region 25b of the first polarization hologram device 25 is converged on the photodetection device 23b, and light diffracted by the region 25c of the first polarization hologram device 25 is converged on the photodetection device 23c.

In contrast to this, in the case where the focal position given by the objective lens 14 is shorter than the optical disk 15a with a result of a defocused state, as shown in FIG. 3B, light diffracted by the region 25a of the first polarization hologram device 25 is converged only on the photodetection region 23al in the two-divisional photodetection device 23a, light diffracted by the region 25b is converged on the photodetection device 23b, and light diffracted by the region 25c is converged on the photodetection device 23c. Meanwhile, when the focal position given by the objective lens 14 is farther than the optical disk 15a with a result of a defocused state, as shown in FIG. 3C, light diffracted by the region 25a of the first polarization hologram device 25 is converged only on the photodetection region 23a2 in the two-divisional photodetection device 23a, light diffracted by the region 25b is converged on the photodetection device 23b, and light diffracted by the region 25c is converged on the photodetection device 23c. Accordingly, by using the outputs Sa1, Sa2 from the photodetection regions 23a1, 23a2 in the two-divisional photodetection device 23a, a focusing error signal (FES) by the single knife edge method can be detected by the following equation:

FES=Sa1−Sa2.

Also, for reproduction of the optical disk 15a on which pit information has been recorded, a tracking error signal 1 (TES1) by the differential phase detection (DPD) method can be detected by detecting a change in phase difference between the signals of the outputs Sb, Sc from the photodetection devices 23b, 23c. Further, for optical disks in which grooves are formed, a tracking error signal 2 (TES2) by the push-pull method can be detected by the following equation:

TES2=Sb−Sc.

Further, an information signal (RF signal) recorded on the optical disk 15a can be reproduced by the following equation:

RF=Sa1+Sa2+Sb+Sc.

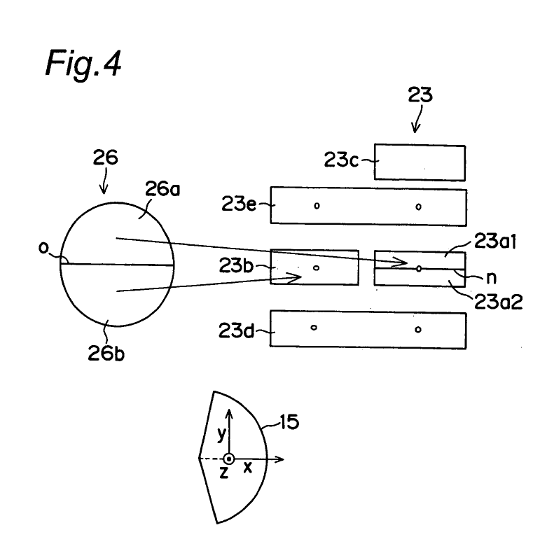

Next, the relationship between the individual diffraction regions of the second polarization hologram device 26 and the individual photodetection devices 23a-23e of the photodetector 23 is explained. As shown in FIG. 4, the second polarization hologram device 26 is divided into two regions 26a, 26b by a parting line o in the x direction, which corresponds to the radial direction of the optical disk 15. In addition, the photodetector 23, which is constituted as described above, is made up of a two-divisional photodetection device 23a and four photodetection devices 23b-23e.

Then, a servo signal detection in reproduction of the above CD is carried out in the following manner. That is, as described above, the return light B′ from the optical disk 15b, originating from the light emitted from the second semiconductor laser 21, is allowed to be incident on the second polarization hologram device 26.

Then, in the case where the optical beam B converged by the objective lens 14 is focused on the information recording surface of the optical disk 15B, out of the incident optical beam B′, light diffracted by the region 26a of the second polarization hologram device 26 is converged on the parting line n of the photodetection regions 23a1, 23a2 in the two-divisional photodetection device 23a, and light diffracted by the region 26b of the second polarization hologram device 26 is converged on the photodetection device 23b.

As described above, light emitted from the second semiconductor laser 21 is split into a main beam and two sub-beams by the three-beam diffraction grating 24. Then, the first sub-beam diffracted by the regions 26a, 26b of the second polarization hologram device 26 is converged to the photodetection device 23e to form two beam spots. Meanwhile, the second sub-beams diffracted by the regions 26a, 26b of the second polarization hologram device 26 is converged to the photodetection device 23d to form two beam spots.

Therefore, as with the DVD, the focusing error signal (FES) can be detected by the following equation:

FES=Sa1−Sa2.

Also, by the three beam method, a tracking error signal 3 (TES3) can be detected by the following equation

TES3=Se−Sd.

Further, an information signal (RF signal) recorded on the optical disk 15b can be reproduced by the following equation:

RF=Sa1+Sa2+Sb.

In this way, servo signals and RF signals can be detected by using the common photodetector 23 having the photodetection devices 23a-23e for the optical disks 15a, 15b of different specifications.

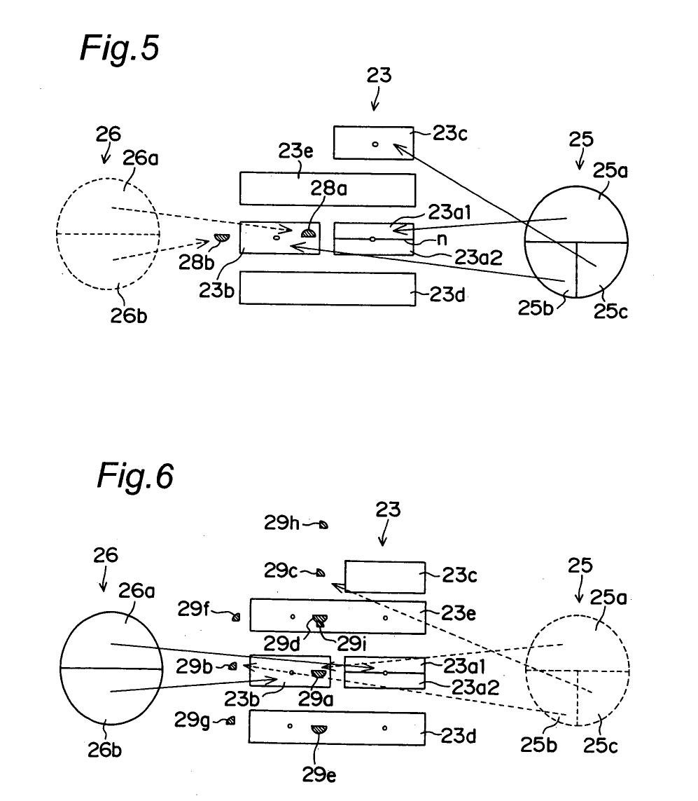

Next, a pattern of photodetection devices of the photodetector 23 other than that of FIG. 3 is explained. FIGS. 5 and 6 show stray light that can occur to the two-divisional photodetection device 23a and the four photodetection devices 23b-23e shown in FIG. 3.

In the optical pickup having a constitution shown in FIG. 2, in principle, optical paths for light beams of different two wavelengths derived from the first, second semiconductor lasers 20, 21 can be completely separated from each other by the composite PBS 18. However, there is a possibility of occurrence of so-called stray light that is not separated by the composite PBS 18 but may leak into the other optical path due to the tolerance of separator film characteristics or wavelength plate characteristics or the wavelength variations or the like of the composite PBS 18.

FIG. 5 shows stray light that becomes incident from the second polarization hologram device 26 side in the case of detecting the light diffracted by the first polarization hologram device 25. As in the case of FIG. 3A, light diffracted by the region 25a of the first polarization hologram device 25 is converged on the parting line n of the two-divisional photodetection device 23a, light diffracted by the region 25b is converged on the photodetection device 23b, and light diffracted by the region 25c is converged on the photodetection device 23c. However, since some part of light transmitted by the polarization beam splitter surface 18a (see FIG. 2) is diffracted by the second polarization hologram device 26, there occur a light spot 28a of the light diffracted by the region 26a of the second polarization hologram device 26 and a light spot 28b of the light diffracted by the region 26b.

The second polarization hologram device 26 is designed for light of the wavelength of 780 nm. Therefore, for light of the wavelength of 650 nm, the diffraction angle would become smaller than the designed one, so that the light would be converged to a position which is closer to the second polarization hologram device 26 than the proper focusing position. Due to this, for example, even if the second polarization hologram device 26 is so designed that the light spot 28a of stray light falls outside the photodetection regions 23a1, 23a2, there is a possibility that the light spot 28a may be incident on the photodetection device 23b, giving adverse effects such as noise or offset, as shown in FIG. 5.

FIG. 6 shows stray light that becomes incident from the first polarization hologram device 25 side in the case of detecting the light diffracted by the second polarization hologram device 26. As in the case of FIG. 4, the main beam and the first and second sub-beams diffracted by the region 26a and region 26b of the second polarization hologram device 26 are converged to the original positions of the photodetection devices of the photodetector 23. In this case, since some part of light reflected by the polarization beam splitter surface 18a is diffracted by the first polarization hologram device 25, there occur light spots 29a-29i of the light diffracted by the regions 25a-25c of the first polarization hologram device 25.

The first polarization hologram device 25 is designed for light of the wavelength of 650 nm. Therefore, for light of the wavelength of 780 nm, the diffraction angle would become larger than the designed one, so that the light would be converged to a position which is farther from the first polarization hologram device 25 than the proper focusing position. Moreover, since the light is split into three beams by the three-beam diffraction grating 24, there occurs stray light of the sub-beams. Due to this, for example, even if the first polarization hologram device 25 is so designed that the light spot 29a and light spot 29c of stray light fall outside the photodetection regions 23a1, 23a2 and the photodetection device 23c, there is a possibility that the light may be incident on the photodetection device 23b that detects the main beam and the photodetection devices 23d, 23e that detect the sub-beams, giving adverse effects, as shown in FIG. 6.

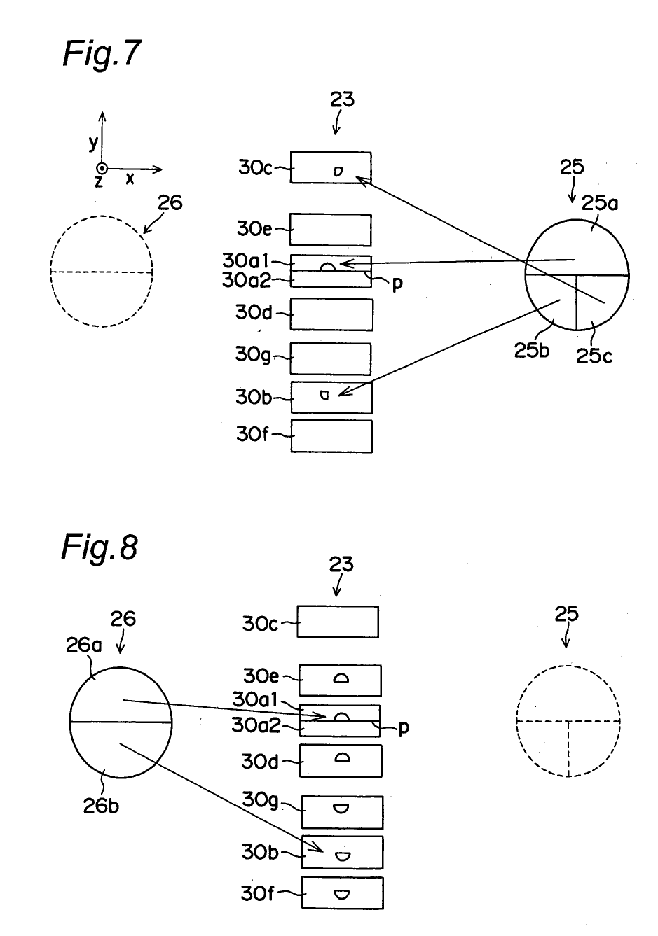

Thus, the photodetection devices of the photodetector 23 are arranged in an array along a direction vertical to a direction determined by interconnecting the first polarization hologram device 25 and the second polarization hologram device 26, as shown in FIGS. 7 and 8. By doing so, in detecting an output of the photodetection devices by incident light derived from one polarization hologram device, it becomes implementable to prevent the incidence of any stray light derived from the other polarization hologram device. As a result, the above-described adverse effects of stray light can be eliminated.

FIG. 7 shows a divisional configuration of the first polarization hologram device 25 and a photodetection device configuration of the photodetector 23. The way of division of the first polarization hologram device 25 is the same as in FIG. 3. Also, the photodetector 23 is made up of a two-divisional photodetection device 30a, which is divided into two photodetection regions 30a1, 30a2 by a parting line p in the x direction, and six photodetection devices 30b-30g. In addition, outputs from the individual photodetection regions 30a1, 30a2 and the individual photodetection devices 30b-30g are designated by Sa1, Sa2 and Sb-Sg, respectively.

For instance, servo signal detection in reproduction of the DVD is carried out as follows. That is, light diffracted by the region 25a of the first polarization hologram device 25 is converged on the parting line p of the photodetection regions 30a1, 30a2 in the two-divisional photodetection device 30a, light diffracted by the region 25b of the first polarization hologram device 25 is converged on the photodetection device 30b, and light diffracted by the region 25c of the first polarization hologram device 25 is converged on the photodetection device 30c. In contrast to this, in the case where the focal position given by the objective lens 14 is shorter than the optical disk 15a with a result of a defocused state, as shown in FIG. 7, light diffracted by the region 25a of the first polarization hologram device 25 is converged only on the photodetection region 30a1 in the two-divisional photodetection device 30a, light diffracted by the region 25b is converged on the photodetection device 30b, and light diffracted by the region 25c is converged on the photodetection device 30c. Accordingly, individual servo signals can be detected by the absolutely same computations as in the case of the photodetection device structure shown in FIG. 3.

Next, the relationship between the individual diffraction regions of the second polarization hologram device 26 and the individual photodetection devices 30a-30g of the photodetector 23 is explained. As shown in FIG. 8, the way of division of the second polarization hologram device 26 is the same as in FIG. 4. Also, the photodetector 23 is constructed as described above, being made up of a two-divisional photodetection device 30a and six photodetection devices 30b-30g.

Then, servo signal detection in reproduction of the CD is carried out as follows. That is, light diffracted by the region 26a of the second polarization hologram device 26 is converged on the parting line p of the photodetection regions 30a1, 30a2 in the two-divisional photodetection device 30a, and light diffracted by the region 26b of the second polarization hologram device 26 is converged on the photodetection device 30b. Further, the first sub-beams diffracted by the regions 26a, 26b of the second polarization hologram device 26 are converged on the photodetection devices 30b and 30g, respectively, and the second sub-beams diffracted by the regions 26a, 26b of the second polarization hologram device 26 are converged on the photodetection devices 30d and 30f, respectively.

In contrast to this, in the case where the focal position given by the objective lens 14 is shorter than the optical disk 15b with a result of a defocused state, as shown in FIG. 8, the main beam diffracted by the region 26a of the second polarization hologram device 26 is converged only on the photodetection region 30al in the two-divisional photodetection device 30a. Meanwhile, the main beam and the first and second sub-beams diffracted by the region 25b are converged on the same photodetection devices as in the foregoing case of the focused state. Accordingly, a focusing error signal (FES) can be detected by the following equation as in the case of the DVD reproduction:

FES=Sa1−Sa2b.

Also, by the three beam method, a tracking error signal 3 (TES3) can be detected by the following equation:

TES3=(Se+Sg)−(Sd+Sf).

Further, an information signal (RF signal) recorded on the optical disk 15b can be reproduced by the following equation:

RF=Sa1+Sa2+Sb.

Also in both cases of reproduction of the DVD and reproduction of the CD, the photodetection devices 30a-30g constituting the photodetector 23 are arranged in an array along a direction vertical to a direction determined by interconnecting the first polarization hologram device 25 and the second polarization hologram device 26. Meanwhile, as described above, stray light that occurs during the DVD reproduction and that is derived from the second polarization hologram device 26 is converged to a position that is closer to the second polarization hologram device 26 than the proper focal position. Also, stray light that occurs during the CD reproduction and that is derived from the first polarization hologram device 25 is converged to a position that is farther from the first polarization hologram device 25 than the proper focal position. Thus, in both cases of DVD reproduction and CD reproduction, stray light derived from the other polarization hologram device is never inputted to any of the photodetection devices 30a-30g, so that the above-described effects of stray light can be eliminated.

As to the placement of the photodetection devices of the photodetector 23 shown in FIG. 4 as well as the placement of the photodetection devices of the photodetector 23 shown in FIG. 8, the detection of the tracking error signal 3 (TES3) in CD reproduction is performed by using the three-beam method. However, the present invention is not limited to this, and the tracking error signal may also be detected by the differential push-pull (DPP) method using three beams as explained below. This is used in pickup optical systems for recording and reproduction such as CD-R.

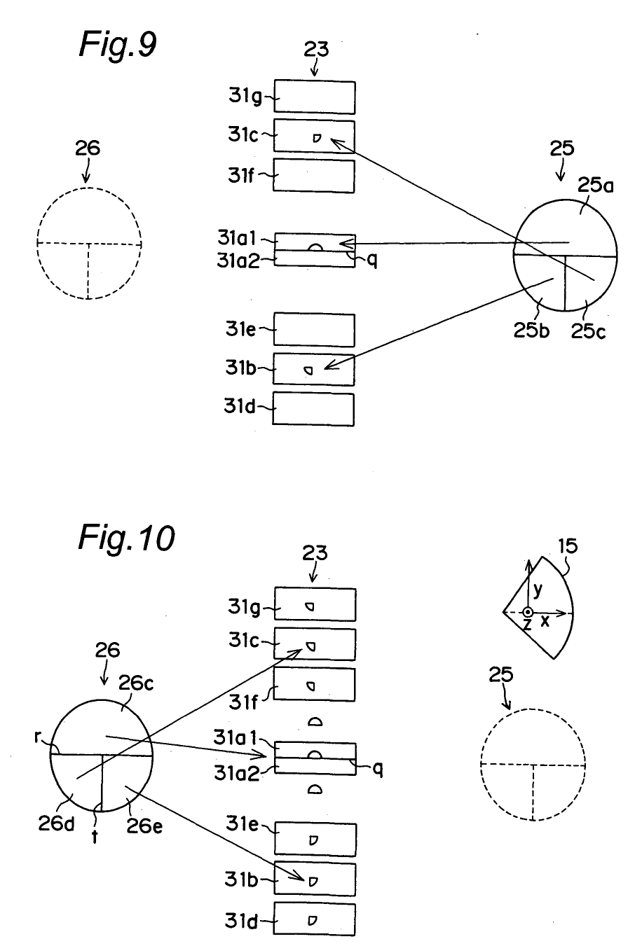

Next, a pattern of photodetection devices of the photodetector 23 other than those of FIGS. 7 and 8 is explained. The divisional configuration of the two polarization hologram devices 25, 26 and the photodetection device configuration of the photodetector 23 in this case are shown in FIGS. 9 and 10.

FIG. 9 shows a divisional configuration of the first polarization hologram device 25 and a photodetection device configuration of the photodetector 23. The way of division of the first polarization hologram device 25 is the same as in FIG. 3. Also, the photodetector 23 is made up of a two-divisional photodetection device 31a, which is divided into two photodetection regions 31a1, 31a2 by a parting line q in the x direction, and six photodetection devices 31b-31g. In addition, outputs from the individual photodetection regions 31a1, 31a2 and the individual photodetection devices 31b-31g are designated by Sa1, Sa2 and Sb-Sg, respectively.

For instance, servo signal detection in reproduction of the DVD is carried out as follows. That is, light diffracted by the region 25a of the first polarization hologram device 25 is converged on the parting line q of the photodetection regions 31a1, 31a2 in the two-divisional photodetection device 31a, light diffracted by the region 25b of the first polarization hologram device 25 is converged on the photodetection device 31b, and light diffracted by the region 25c of the first polarization hologram device 25 is converged on the photodetection device 31c. In contrast to this, in the case where the focal position is shorter than the optical disk 15a with a result of a defocused state, as shown in FIG. 9, light diffracted by the region 25a of the first polarization hologram device 25 is converged only on the photodetection region 31a1 in the two-divisional photodetection device 31a. Meanwhile, light beams diffracted by the regions 25b, 25c are converged on the same photodetection devices as in the foregoing case of the focused state. Accordingly, individual servo signals and RF signals can be detected by the absolutely same computations as in the case of the photodetection device structure shown in FIG. 3.

Next, the relationship between the individual diffraction regions of the second polarization hologram device 26 and the individual photodetection devices 31a-31g of the photodetector 23 is explained. As shown in FIG. 10, the second polarization hologram device 26 is divided into three regions 26c-26e by a parting line r in the x direction, which corresponds to the radial direction of the optical disk 15, and a parting line t in the y direction, which corresponds to the track direction. Also, the photodetector 23 is constructed as described above, being made up of a two-divisional photodetection device 31a and six photodetection devices 31b-31g.

Then, servo signal detection in reproduction of the CD is carried out as follows. That is, light diffracted by the region 26c of the second polarization hologram device 26 is converged on the parting line q of the photodetection regions 31a1, 31a2 in the two-divisional photodetection device 31a, light diffracted by the region 26d of the second polarization hologram device 26 is converged on the photodetection device 31c, and light diffracted by the region 26e of the second polarization hologram device 26 is converged on the photodetection device 31b. Further, the first and second sub-beams diffracted by the region 26e of the second polarization hologram device 26 are converged on the photodetection device 31e and the photodetection device 31d, respectively, and the first and second sub-beams diffracted by the region 26d of the second polarization hologram device 26 are converged on the photodetection device 31g and the photodetection device 31f, respectively.

In contrast to this, in the case where the focal position is shorter than the optical disk 15b with a result of a defocused state, as shown in FIG. 10, the main beam diffracted by the region 26c of the second polarization hologram device 26 is converged only on the photodetection region 31al in the two-divisional photodetection device 31a. Meanwhile, the main beam and the first and second sub-beams diffracted by the regions 26d, 26e are converged on the same photodetection devices as in the foregoing case of the focused state. Accordingly, a focusing error signal (FES) can be detected by the following equation as in the case of the DVD reproduction:

FES=Sa1−Sa2.

Also, by the differential push-pull (DPP) method, a tracking error signal 4 (TES4) can be detected with the use of a push-pull signal TES5 of the main beam and push-pull signals TES(A) and TES(B) of the first and second sub-beams by the following equation:

TES4=TES5−k·(TES(A)+TES(B))=(Sa1−Sa2)−k·((Sg−Sf)+(Se−Sd)),

where the coefficient k is intended to correct a difference in light intensity between the main beam and the sub-beams, where if the intensity ratio of main beam:first sub-beam:second sub-beam=a:b:b, then coefficient k=a/(2b).

Further, an information signal (RF signal) recorded on the optical disk 15b can be reproduced by the following equation:

RF=Sa1+Sa2+Sb+Sc.

In this case also, the photodetection devices 31a-31g constituting the photodetector 23 are arranged in an array along a direction vertical to a direction determined by interconnecting the first polarization hologram device 25 and the second polarization hologram device 26. Thus, in both cases of DVD reproduction and CD reproduction, stray light derived from the other polarization hologram device is never inputted to any of the photodetection devices 31a-31g, so that the above-described effects of stray light can be eliminated.

Further, the second polarization hologram device 26 is divided into three regions 26c-26e. Therefore, a tracking error signal 4 (TES4) can be detected by the differential push-pull (DPP) method using three beams. That is, applying the photodetection device structure of the photodetector 23 shown in FIGS. 9 and 10 makes it possible to perform recording and reproduction on CD-Rs in which the tracking error signal detection method by the DPP technique is used.

As shown above, in this embodiment, the integrated laser unit 11 made up by stacking the laser package 16, the transparent substrate 17 and the composite PBS 18 one by one is provided on the light source side. Then, in the laser package 16 are integrated the first semiconductor laser 20 that oscillates on the 650 nm band, the second semiconductor laser 21 that oscillates on the 780 nm band and the photodetector 23. Also, the composite PBS 18 is so constructed that it transmits generally 100% of p-polarized light and reflects generally 100% of s-polarized light with respect to the wavelength derived from the first semiconductor laser 20, while the composite PBS 18 transmits generally 100% of both p-polarized light and s-polarized light with respect to the wavelength derived from the second semiconductor laser 21. Then, on the composite PBS 18 is stacked the wavelength plate 27 that acts as a ¼ wavelength plate against the light beams from the first, second semiconductor lasers 20, 21 to generate corresponding phase difference.

Thus, a beam of p-polarized light derived from the first semiconductor laser 20 of the 650 nm band is used for the DVD reproduction, while a beam of p-polarized light derived from the second semiconductor laser 21 of the 780 nm band is used for the CD reproduction. By doing so, the beams of s-polarized light, reflected by the optical disk 15, are separated by the composite PBS 18.

Then, at different positions on the transparent substrate 17, which are the incidence position of return light (s-polarized light) of the first semiconductor laser 20 and the incidence position of return light (s-polarized light) of the second semiconductor laser 21, the beams of return light being separated from each other as described above, are provided the first, second polarization hologram devices 25, 26 that change generally all of the s-polarized light into ±1st-order light, so that the light beams which are derived from the first, second semiconductor lasers 20, 21 and which have once been separated by the composite PBS 18, are converged to one photodetector 23.

Therefore, according to this embodiment, by independently adjusting the first, second polarization hologram devices 25, 26 which are provided on the transparent substrate 17 independently of each other, the offset adjustment of servo error signals for both first and second semiconductor lasers 20 and 21 can be easily achieved in the process of assembly even in the case where the first, second semiconductor lasers 20, 21 and the photodetector 23 are integrated in one laser package 16. Thus, there can be provided an optical pickup which is easy to assemble and adjust and which is suitable for downsizing and integration.

Also, polarization hologram devices that allow generally all of the s-polarized light to become ±1st-order light are used as the first, second polarization hologram devices 25, 26. Thus, all the return light (s-polarized light) derived from the optical disk 15 can be led to the photodetector 23, so that the use efficiency of light can be largely improved.

Also, in the transparent substrate 17 is formed the three-beam diffraction grating 24 that transmits the light derived from the first semiconductor laser 20 of the 650 nm band while it splits the light derived from the second semiconductor laser 21 of the 780 nm band into three beams for use of tracking control. Accordingly, by setting the configuration, number and position of the plurality of photodetection devices constituting the photodetector 23 to optimum ones, it becomes implementable to detect different tracking error signals of the three-beam method, the differential phase method and the push-pull method.

Also, the first, second polarization hologram devices 25, 26 are provided independently of each other. Therefore, the first polarization hologram device 25 can be given an aberration correcting function for an oscillation wavelength of 650 nm while the second polarization hologram device 26 can be given an aberration correcting function for an oscillation wavelength of 780 nm, thus making it possible to achieve an optimum aberration correction for different plural wavelengths. Thus, desired focusing property on the photodetector 23 can be obtained.

Second Embodiment:

This embodiment relates to an optical pickup for performing recording and reproduction on optical disks such as CD-R or CD-RW (CD-Writable) with combinational use of a high-power semiconductor laser.

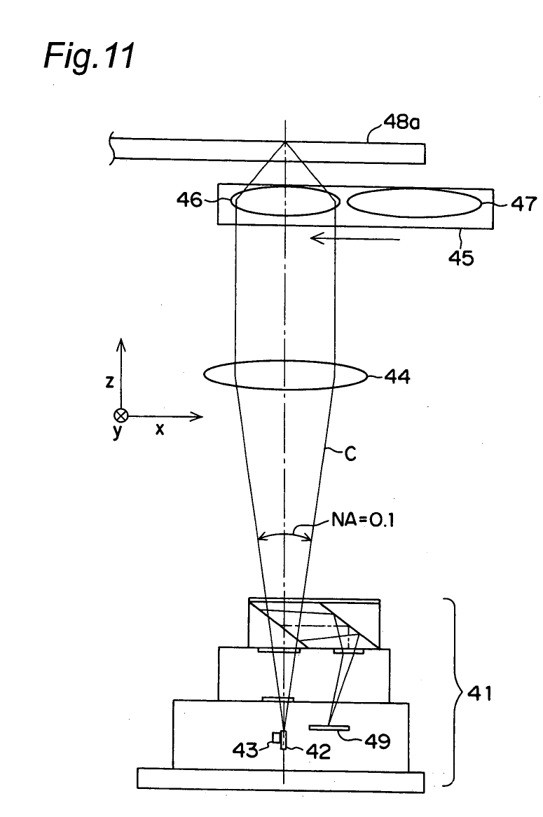

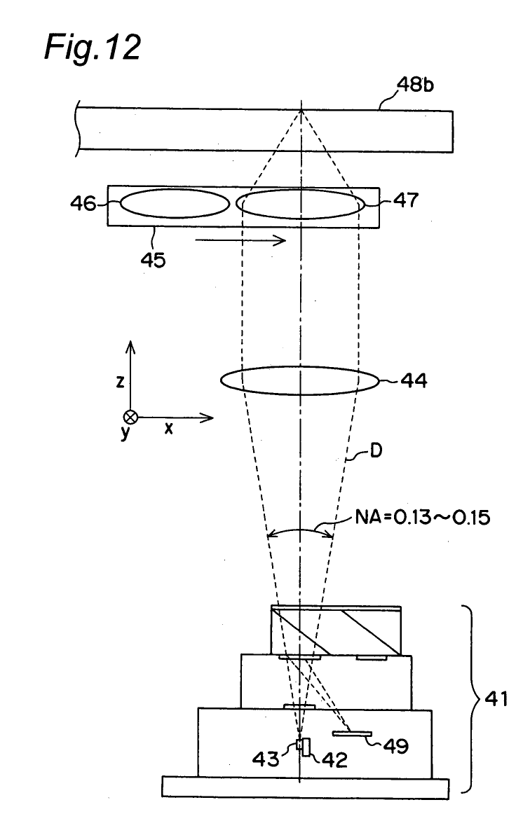

FIGS. 11 and 12 are views showing the construction of the optical pickup of this embodiment. In FIGS. 11 and 12, an integrated laser unit 41 basically has the same constitution as the integrated laser unit 11 of the first embodiment. Reference numeral 42 denotes a first semiconductor laser which oscillates on a 650 nm band, 43 denotes a second semiconductor laser which oscillates on a 780 nm band, and 49 denotes a photodetector. It is noted that the second semiconductor laser 43 in this embodiment is a high-power laser.

In conjunction with the servo signal detection, providing a photodetector 49 having a construction similar to those of FIG. 9 and FIG. 10 makes it possible to fulfill the servo signal detection that is applicable to CD-Rs or CD-RWs in which the DPP method is utilized for the detection of TES′. However, in order to correct the difference in disc thickness between DVDs and CDs, the optical system shown in FIG. 1 employs the wavelength-selector aperture 13 as well as a special objective lens 14 which is corrected in part of its aspherical shape.

With such a constitution, for example, if the NA of the collimator lens 12 is designed in accordance with the DVD system that requires stricter focusing conditions, the substantial NA of the collimator lens 12 would be reduced because of the aperture restriction applied to the CD system by the wavelength-selector aperture 13.

Normally, optical pickups for use as recording discs such as CD-R need to be increased in outgoing light quantity of the objective lens. Therefore, the NA of the collimator lens is increased so that the use efficiency of light from the semiconductor-laser light source is improved, as compared with optical pickups for use as CD-ROMs (Read Only Memories) dedicated solely to reproduction. However, in the optical pickup of the foregoing first embodiment, because of the use of the integrated laser unit 11 on which the two semiconductor lasers 20, 21 placed in proximity to each other and different in wavelength from each other is mounted, it is impossible to freely set the NA of the collimator lens 12 during the use of an optical system of the CD system.

Thus, in this embodiment, the optical pickup for performing recording and reproduction on CD-Rs or CD-RWs is given in such a constitution as shown in FIGS. 11 and 12. FIG. 11 shows optical paths for reproduction of a DVD, and FIG. 12 shows optical paths for recording and reproduction on a CD-R or CD-RW.

Referring to FIG. 11, light C emitted from the first semiconductor laser 42 in the integrated laser unit 41 is collimated by a collimator lens 44 and converged to an optical disk 48a by a DVD-use objective lens 46. In this case, the DVD-use objective lens 46 is provided together with a CD-use objective lens 47 in an objective-lens actuator 45. Reflected light from the optical disk 48a, retracing the same optical system as that in the forward direction, is focused on the photodetector 49 of the integrated laser unit 41 in the same manner as in the foregoing first embodiment.

Meanwhile, for recording and reproduction of the CD-R or CD-RW, as shown in FIG. 12, light D emitted from the second semiconductor laser 43 in the integrated laser unit 41 is collimated by the collimator lens 44 and converged to an optical disk 48b by the CD-use objective lens 47 switchedly selected by the objective-lens actuator 45. Reflected light from the optical disk 48b, retracing the same optical system as that in the forward direction, is focused on the photodetector 49 of the integrated laser unit 41 in the same manner as in the foregoing first embodiment.

In this case, the effective diameter of the CD-use objective lens 47 in the objective-lens actuator 45 is set larger than the effective diameter of the DVD-use objective lens 46. Accordingly, for recording and reproduction of the CD-R or CD-RW, the substantial NA of the collimator lens 44 can be enlarged by switchedly selecting the CD-use objective lens 47 by the objective-lens actuator 45. By doing so, it becomes implementable to improve the use efficiency of light of the CD system with the use of the collimator lens 44 common to DVD and CD-R or CD-RW.

In addition, the switching selection between the DVD-use objective lens 46 and the CD-use objective lens 47 by the objective-lens actuator 45 is enabled by implementing the objective-lens actuator 45 by a two-lens actuator of the slide shaft type. Also, appropriately, the substantial NA of the collimator lens 44 is set to about 0.1 for the DVD system and to about 0.13 to 0.15 for the CD system.

Third Embodiment:

This embodiment relates to an optical pickup for performing recording and reproduction on optical disks such as DVDs and CDs and this optical pickup is different from that of the first embodiment.

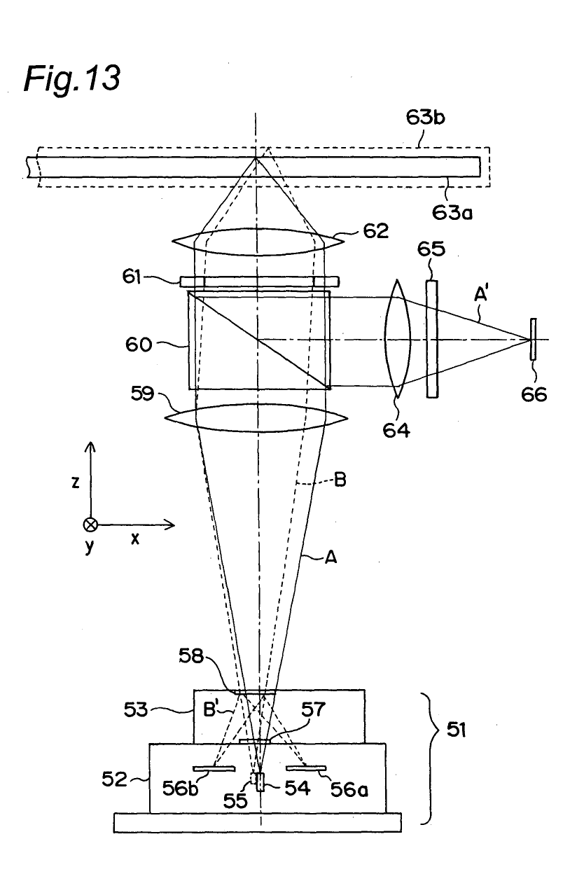

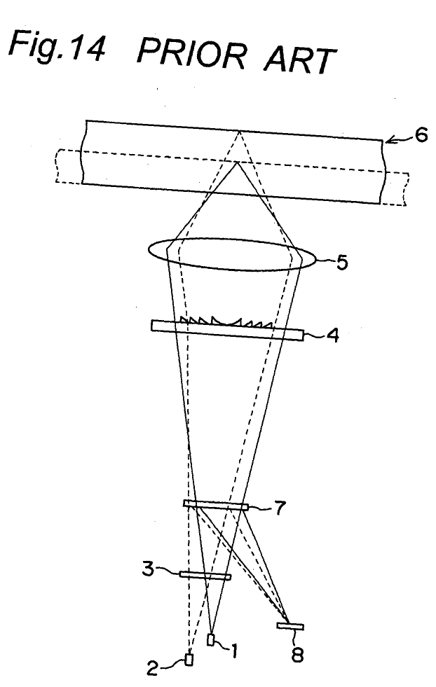

FIG. 13 is a view showing a constitution of the optical pickup of this embodiment. The optical pickup of this embodiment differs from that of the first embodiment in that reflected light from the optical disk is split into an optical path for reflected light from the DVD and an optical path for reflected light from the CD so that the beams of reflected light are led to different photodetectors, respectively.

Referring to FIG. 13, an integrated laser unit 51 is so constructed that a laser package 52 and a transparent substrate 53 are stacked, and moreover integrally bonded and fixed, on a substrate. Further, the laser package 52 contains therein a first semiconductor laser 54 that oscillates on a 650 nm band and a second semiconductor laser 55 that oscillates on a 780 nm band, the two semiconductor lasers being disposed in proximity to each other, and a photodetector 56 composed of two photodetection devices 56a, 56b.

Also, on one surface of the transparent substrate 53 in close contact with the laser package 52, a three-beam diffraction grating 57 for generating three beams for use of tracking control is formed at a position opposite the first, second semiconductor lasers 54, 55. Further, on the surface of the transparent substrate 53 which is not in close contact with the laser package 52 is formed a polarization hologram device 58 which diffracts an optical beam of the second semiconductor laser 55 applied from external to lead the beam to the photodetector 56. This polarization hologram device 58 functions in the same manner as the second polarization hologram device 26 of the first embodiment.

Furthermore, a dichroic prism 60 is disposed between a collimator lens 59 and a wavelength-selector aperture 61. This dichroic prism 60 serves as a partial reflection device for an optical beam A derived from the first semiconductor laser 54 of the 650 nm band so that part of return light A′ reflected by an optical disk 63a is reflected toward a direction vertical to its optical axis. For an optical beam B derived from the second semiconductor laser 55 of the 780 nm band, on the other hand, the dichroic prism 60 serves as a transparent device so that return light B′ reflected by an optical disk 63b is scarcely reflected, with a result of almost no optical loss.

The wavelength-selector aperture 61 operates in such a manner that, for example, light of 650 nm is transmitted therethrough while light of 780 nm is subjected to an aperture restriction, as in the first embodiment. Furthermore, the wavelength-selector aperture 61 acts as a ¼ wavelength plate for the optical beam B of the wavelength of 780 nm so that the optical beam B incident as linearly polarized light is transformed into circularly polarized light while the return light B′ of circularly polarized light reflected by the optical disk 63b is transformed into linearly polarized light having a polarization direction perpendicular to the polarization direction of the original optical beam B. In contrast to this, the wavelength-selector aperture 61 does not act as a perfect ¼ wavelength plate for the optical beam A of the wavelength of 650 nm.

An objective lens 62 which converges an optical beam derived from the wavelength-selector aperture 61 onto an optical disk 63 is so designed that its position is movable in the direction of the optical axis. Further, the objective lens 62 is so designed as to converge light to such an extent that a sufficiently small spherical aberration of the optical beams A, B can be obtained with respect to the two optical disks 63a, 63b, respectively which are different in thickness from each other, i.e., that enough reading of signals on the optical disks 63a, 63b is enabled.

Also, on the optical axis of the return light A′ reflected by the dichroic prism 60 are arrayed a collimator lens 64, a polarization hologram device 65 and a photodetector 66 in this order, as listed from the dichroic prism 60 side. Hereinafter, the collimator lens 59 is referred to as first collimator lens, and the collimator lens 64 is referred to as second collimator lens. Also, the polarization hologram device 58 is referred to as second polarization hologram device, and the polarization hologram device 65 is referred to as first polarization hologram device. Also, the photodetector 66 is referred to as first photodetector, and the photodetector 56 is referred to as second photodetector.

In this case, the second collimator lens 64 converges return light A′ reflected by the dichroic prism 60 to focus the light on the first photodetector 66. Also, the first polarization hologram device 65 splits the optical beam A′ into three beams and converges the beams on the first photodetector 66, as the first polarization hologram device 25 of the first embodiment does, so that the tracking error signal 1 (TES1), the tracking error signal 2 (TES2) and the focusing error signal (FES) can be detected.

The optical pickup having the above constitution operates as follows for reproduction of the DVD. That is, the optical beam A of p-polarized light emitted from the first semiconductor laser 54 of the 650 nm band is split into three beams of 0th-order light and ±1st-order light by the three-beam diffraction grating 57. Then, the beams are formed into 0th-order light by the second polarization hologram device 58 and led to the first collimator lens 59 as such. Then, the beam is collimated by the first collimator lens 59, transmitted by the dichroic prism 60 and the wavelength-selector aperture 61, and converged on the optical disk 63a by the objective lens 62.

Then, the return light A′ reflected by the optical disk 63a is transmitted by the objective lens 62 and the wavelength-selector aperture 61, and reflected by the dichroic prism 60 toward a direction vertical to its optical axis. Then, after transmitted by the second collimator lens 64, the beam is diffracted by the first polarization hologram device 65, and converged on the individual photodetection devices (not shown) of the first photodetector 66.

In contrast to this, for reproduction of the CD, as in the case of reproduction of the DVD, the optical beam B of p-polarized light emitted from the second semiconductor laser 55 of the 780 nm band is transmitted by the three-beam diffraction grating 57, the second polarization hologram device 58, the first collimator lens 59, the dichroic prism 60 and the wavelength-selector aperture 61, and converged on the optical disk 63b by the objective lens 62. In this operation, the p-polarized light is transformed into circularly polarized light by the wavelength-selector aperture 61.

Then, the return light B′ of circularly polarized light reflected by the optical disk 63b is transmitted by the objective lens 62, the wavelength-selector aperture 61 and the dichroic prism 60. In this operation, the circularly polarized light is transformed into s-polarized light by the wavelength-selector aperture 61. Then, after transmitted by the first collimator lens 59, the beam is formed into ±1st-order light by the second polarization hologram device 58, and the resulting beams are converged on one set of photodetection devices 56a, 56b constituting the second photodetector 56, so that the tracking error signal 1 (TES1), the tracking error signal 2 (TES2) and the focusing error signal (FES) can be detected. Thus, by virtue of the use of ±1st-order light for the detection of error signals, it becomes possible even to employ, for example, the spot size detection method as the FES detection method.

As described above, the return light B′ reflected by the optical disk 63b is diffracted by the second polarization hologram device 58, resulting in ±1st-order light. In this operation, almost no 0th-order light is generated. This is because the polarization ratio of laser beams becomes high enough after having been transmitted through the second polarization hologram device 58 in the forward path. More specifically, the polarization ratio of laser beams emitted from the light source is, generally, about 100:1 (intensity of light polarized in a first direction:intensity of light polarized in a second direction perpendicular to the first direction), and the polarization selectivity of the second polarization hologram device 58 is about 20:1. Therefore, after a one-time transmission through the second polarization hologram device 58, the polarization ratio becomes about 2000:1, which is a polarization ratio beyond a ratio of 700:1 that allows measurement by the normal Glan-Thompsom prism.

As described above, in this embodiment, the optical path for the return light A′ from the optical disk 63a, originating from the optical beam A derived from the first semiconductor laser 54 of the 650 nm band, and the optical path for the return light B′ from the optical disk 63b, originating from the optical beam B derived from the second semiconductor laser 55 of the 780 nm band, are separated from each other, so that the beams of return light are led to the different photodetectors of the first photodetector 66 and the second photodetector 56. Therefore, it becomes possible to adopt detection methods suitable for information signals recorded on the optical disks 63a, 63b, respectively. It becomes also implementable to obtain quite a high use efficiency of light for the optical beam B, which is used for reproduction of the CD. Accordingly, this embodiment is effective for use with write-use CD-R/RW's that demand high optical power.

Furthermore, needless to say, when the wavelength-selector aperture 61 that functions as the ¼ wavelength plate is given by a broad-band one so that the laser beam of either wavelength is transformed so as to make the polarization direction of the forward path and the polarization direction of the return path perpendicular to each other, and when the dichroic prism 60 is given by a composite polarization beam splitter, it becomes implementable to eliminate the loss of the optical beam A of the 650 nm wavelength in the forward path so that the use efficiency of light can be further enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical pickup having a first light source for generating an optical beam of a first wavelength, a second light source for generating an optical beam of a second wavelength different from the first wavelength, an optical system for converging the optical beams derived from the two light sources onto an optical disk, and a photodetector for detecting reflected light derived from the optical disk, the optical pickup further comprising:
an optical device for separating the light of the first wavelength and the light of the second wavelength reflected by the optical disk from each other;
a first hologram device for diffracting the light of the first wavelength separated by the optical device so as to make the light incident on the photodetector; and
a second hologram device for diffracting the light of the second wavelength separated by the optical device so as to make the light incident on the photodetector, wherein
at least one of the two hologram devices is a polarization hologram device.

2. The optical pickup according to claim 1, wherein
the first light source, the second light source, the photodetector, the optical device, the first hologram device and the second hologram device are integrated into one unit.

3. The optical pickup according to claim 1, wherein
the optical device is a wavelength-splitting prism which differs in reflectivity depending on wavelength,
the first hologram device diffracts light reflected by the wavelength-splitting prism so as to make the light incident on the photodetector, and
the second hologram device diffracts light transmitted by the wavelength-splitting prism so as to make the light incident on the photodetector.

4. The optical pickup according to claim 1, wherein
the optical device is a composite polarization beam splitter having characteristics that the composite polarization beam splitter transmits generally all of p-polarized light and reflects generally all of s-polarized light out of the optical beam of the first wavelength while the composite polarization beam splitter transmits generally all of both p-polarized light and s-polarized light out of the optical beam of the second wavelength,
the optical pickup further comprises a ¼ wavelength plate which rotates a polarization direction of the light of the first wavelength by 90 degrees and which is disposed between the composite polarization beam splitter and the optical system,
the first hologram device diffracts light reflected by the composite polarization beam splitter so as to make the light incident on the photodetector, and
the second hologram device diffracts light transmitted by the composite polarization beam splitter so as to make the light incident on the photodetector.

5. The optical pickup according to claim 4, wherein
the ¼ wavelength plate rotates a polarization direction of light of the second wavelength as well by 90 degrees.

6. The optical pickup according to claim 5, wherein
the ¼ wavelength plate is adhesively fixed to a surface of the composite polarization beam splitter confronting the optical system.

7. The optical pickup according to claim 5, wherein
the first hologram device and the second hologram device are polarization hologram devices which are so set that ±1st-order diffraction efficiency of the s-polarized light and 0th-order diffraction efficiency of the p-polarized light are maximized while 0th-order diffraction efficiency of the s-polarized light and ±1st-order diffraction efficiency of the p-polarized light are minimized.

8. The optical pickup according to claim 1, wherein
the photodetector includes a divisional photodetection device which is two-divided so as to have two photodetection regions by a parting line extending along a direction corresponding to a radial direction of the optical disk,
meanwhile, the first hologram device and the second hologram device each include one diffraction region resulting from the two-division by the parting line extending along the direction corresponding to the radial direction of the optical disk, and wherein
upon focusing, light diffracted at the one diffraction region out of the optical beam of the first wavelength and the optical beam of the second wavelength forms a light spot on the parting line of the divisional photodetection device.

9. The optical pickup according to claim 1, wherein
a three-beam diffraction grating is provided between the first, second light sources and the second hologram device.

10. The optical pickup according to claim 9, wherein
the three-beam diffraction grating is a wavelength-selective diffraction grating which transmits generally all of the optical beam of the first wavelength and splits the optical beam of the second wavelength into three beams of 0th-order light and ±1st-order light.

11. The optical pickup according to claim 10, wherein
the photodetector is made up of a plurality of photodetection devices which are arrayed in such a manner that a tracking error signal of a differential phase method or a push-pull method can be detected based on light diffracted by the first hologram device and that a tracking error signal of a three-beam method or a differential push-pull method can be detected based on light diffracted by the second hologram device.

12. The optical pickup according to claim 10, wherein
the wavelength-selective diffraction grating is a polarization hologram.

13. The optical pickup according to claim 10, wherein
the wavelength-selective diffraction grating is a hologram adjusted in groove depth.

14. The optical pickup according to claim 1, wherein
the photodetector is made up of a plurality of photodetection devices which are arrayed in such a manner that diffracted light of the optical beam of the second wavelength by the first hologram device is not made incident on the photodetector.

15. The optical pickup according to claim 1, wherein
the photodetector is made up of a plurality of photodetection devices which are arrayed in such a manner that diffracted light of the optical beam of the first wavelength by the second hologram device is not made incident on the photodetector.

16. The optical pickup according to claim 1, wherein
the photodetector comprises a first photodetector on which diffracted light from the first hologram device comes incident, and a second photodetector on which diffracted light from the second hologram device comes incident.

17. The optical pickup according to claim 1, wherein
the first light source is a first semiconductor laser which oscillates on a 650 nm band, and
the second light source is a second semiconductor laser which oscillates on a 780 nm band.

18. The optical pickup according to claim 17, wherein
at least one of the first semiconductor laser and the second semiconductor laser is a high-power laser, and
recording and reproduction onto the optical disk with the high-power laser is enabled.
